(19) United States
(12) Patent Application Publication
(10) Pub. No.: US 2013/0136092 A1
(43) Pub. Date: May 30, 2013

(54) SENDING METHOD AND DEVICE FOR 8-ANTENNA DOWNLINK CONTROL CHANNEL

(71) Applicants: Dajie Jiang, Beijing (CN); Lu Han, Beijing (CN); Xiaozhou Wang, Beijing (CN); Lijie Hu, Beijing (CN); Yong Zhang, Beijing (CN); Zhihua Shi, Beijing (CN); Guangyi Liu, Beijing (CN)

(72) Inventors: Dajie Jiang, Beijing (CN); Lu Han, Beijing (CN); Xiaozhou Wang, Beijing (CN); Lijie Hu, Beijing (CN); Yong Zhang, Beijing (CN); Zhihua Shi, Beijing (CN); Guangyi Liu, Beijing (CN)

(73) Assignee: CHINA MOBIL COMMUNICATIONS CORPORATION, Beijing (CN)

(21) Appl. No.: 13/814,505

(22) PCT Filed: Jul. 22, 2011
(86) PCT No.: PCT/CN2011/077468

§ 371 Date: Feb. 6, 2013

(30) Foreign Application Priority Data
Aug. 23, 2010 (CN) 101010261177.9

(51) Int. Cl. H04B 7/06

(52) U.S. Cl. CPC H04B 7/06
USPC 370/329

(57) ABSTRACT

A method for an 8-antenna downlink control channel, is described. the method includes virtualizing a first pair and a third pair of dual-polarized antennas as a first port, and virtualizing a second pair and a fourth pair of dual-polarized antennas as a second port. The weighted values of the broadcast right of the four antennas in the first port satisfy that the weighted value of one antenna is +1 and the weighted values of the other three antennas are −1, or the weighted value of one antenna is −1 and the weighted values of the other three antennas are +1, and weighted values of the broadcast right of the four antennas in the second port satisfy that the weighted value of one antenna is +1 and the weighted values of the other three antennas are −1.

This application claims the benefit of Chinese Patent Application No. 201010261177.9, filed with the Chinese Patent Office on Aug. 23, 2010 and entitled “METHOD OF AND APPARATUS FOR TRANSMITTING DOWNLINK CONTROL CHANNEL ON 8 ANTENNAS”, which is hereby incorporated by reference in its entirety.

### FIELD

The present invention relates to the field of antenna technologies and in particular o a method of and apparatus for transmitting a downlink control channel on 8 antennas.

### BACKGROUND

At present, a Time Division Duplex-Long Term Evolution (TD-LTE) base station adopts 8 antennas for downlink transmission, and a Frequency Division Duplex (FDD) base station adopts 2 antennas for downlink transmission. If the total power of all antennas is the same for the TDD base station and the FDD base station, for example, both are 40 W, then the power of each antenna among the 8 antennas of the TDD base station is 5 W and the power of each antenna among the 2 antennas of the FDD base station is 20 W.

A downlink control channel of the base station is transmitted in a 2×2 Space Frequency Block Coding (SFBC) scheme. A downlink control channel of the TD-LTE base station can be transmitted in two major categories of schemes, and the first category is a 4-port based scheme, e.g., SFBC plus Frequency Switched Transmit Diversity (FSTD). A non-negligible drawback of the 4-port scheme is that Common Reference Signals (CRSs) of the 4 ports have to be occupied, thus resulting in a considerable overhead of pilots; and the second category is a weighted broadcast scheme, and FIG. 1 illustrates a schematic diagram of the existing TD-LTE base station transmitting a downlink control channel in the weighted broadcast scheme, and as illustrated in FIG. 1, this scheme continues the use of the 2-port scheme of the FDD base station, that is, the 8 antennas are grouped and virtualized in 2 antenna ports, where one port (i.e., a port 0) is virtually consisted of 4 antennas in the direction of +45 degrees, and the other port (i.e., a port 1) is virtually consisted of 4 antennas in the direction of −45 degrees, and then the downlink control channel is transmitted through 2×2 SFBC. The weighted broadcast scheme has a lower overhead of pilots than the 4-port scheme due to the use of the 2 ports and thus can be attractive to some extent. However in the weighted broadcast scheme, weights on some antennas among the 4 antennas of the same port are below 1, thus resulting in such a loss of power that a coverage area of a downlink control channel of the 2 antennas of the FDD base station at the same total power may not be achieved.

### SUMMARY

The invention provides a method of and apparatus for transmitting a downlink control channel so as to extend a coverage area of a downlink control channel of a base station with 8 antennas.

Technical solutions of the invention are embodied as follows:

A method of transmitting a downlink control channel on 8 antennas includes:

for the 8 antennas used by a base station for downlink transmission, virtualizing the first and third pairs of dual-polarized antennas into a first port and virtualizing the second and fourth pairs of dual-polarized antennas into a second port,

wherein broadcast weights of the 4 antennas of the first port satisfy that the weight of one of the antennas is +1 and the weights of the remaining three antennas are −1, or the weight of one of the antennas is −1 and the weights of the remaining three antennas are +1, and

broadcast weights of the 4 antennas of the second port satisfy that the weight of one of the antennas is +1 and the weights of the remaining three antennas are −1, or the weight of one of the antennas is −1 and the weights of the remaining three antennas are +1; and

the base station transmitting a downlink control signal through the first port and the second port.

The base station is a Long Term Evolution, LTE, Time Division Duplex, TDD, base station or an LTE-A TDD base station or an LTE Frequency Division Duplex, FDD, base station or an LTE-A FDD base station.

A method of transmitting a downlink control channel on 8 antennas includes:

for the 8 antennas used by a base station for downlink transmission, virtualizing the first pair and fourth pairs of dual-polarized antennas into a first port and virtualizing the second and third pairs of dual-polarized antennas into a second port,

wherein as broadcast weights of the 4 antennas of the first port, the weight of one of the antennas is +1 and the weights of the remaining three antennas are −1, or the weight of one of the antennas is −1 and the weights of the remaining three antennas are +1, and

as broadcast weights of the 4 antennas of the second port, the weight of one of the antennas is +1 and the weights of the remaining three antennas are −1, or the weight of one of the antennas is −1 and the weights of the remaining three antennas are +1; and

the base station transmitting a downlink control signal through the first port and the second port.

The base station is a Long Term Evolution, LTE, Time Division Duplex, TDD, base station or an LTE-A TDD base station or an LTE Frequency Division Duplex, FDD, base station or an LTE-A FDD base station.

A method of transmitting a downlink control channel on 8 antennas includes: for the 8 antennas used by a base station for downlink transmission, virtualizing the antennas in the direction of +45 degrees among the first and second pairs of dual-polarized antennas and the antennas in the direction of −45 degrees among the third and fourth pairs of dual-polarized antennas into a first port and virtualizing the antennas in the direction of −45 degrees among the first and second pairs of dual-polarized antennas and the antennas in the direction of +45 degrees among the third and fourth pairs of dual-polarized antennas into a second port,

wherein as broadcast weights of the 4 antennas of the first port, the weight of one of the antennas is +1 and the weights of the remaining three antennas are −1, or the weight of one of the antennas is −1 and the weights of the remaining three antennas are +1; and

as broadcast weights of the 4 antennas of the second port, the weight of one of the antennas is +I and the weights of the remaining three antennas are −1, or the weight of one of the antennas is −1 and the weights of the remaining three antennas are +1; and

the base station transmitting a downlink control signal through the first port and the second port.

The base station is a Long Term Evolution, LTE, Time Division Duplex, TDD, base station or an LTE-A TDD base station or an LTE Frequency Division Duplex, FDD, base station or an LTE-A FDD base station.

A method of transmitting a downlink control channel on 8 antennas includes: for the 8 antennas used by a base station for downlink transmission, virtualizing the antennas in the direction of +45 degrees among the first and third pairs of dual-polarized antennas and the antennas in the direction of −45 degrees among the second and fourth pairs of dual-polarized antennas into a first port and virtualizing the antennas in the direction of −45 degrees among the first and third pairs of dual-polarized antennas and the antennas in the direction of +45 degrees among the second and fourth pairs of dual-polarized antennas into a second port,

wherein as broadcast weights of the 4 antennas of the first port, the weight of one of the antennas is +1 and the weights of the remaining three antennas are −1, or the weight of one of the antennas is −1 and the weights of the remaining three antennas are +1, and

as broadcast weights of the 4 antennas of the second port, the weight of one of the antennas is +1 and the weights of the remaining three antennas are −1, or the weight of one of the antennas is −1 and the weights of the remaining three antennas are +1; and

the base station transmitting a downlink control signal through the first port and the second port.

The base station is a Long Term Evolution, LTE, Time Division Duplex, TDD, base station or an LTE-A TDD base station or an LTE Frequency Division Duplex, FDD, base station or an LTE-A FDD base station.

A method of transmitting a downlink control channel on 8 antennas includes:

for the 8 antennas used by a base station for downlink transmission, virtualizing the antennas in the direction of +45 degrees among the first and fourth pairs of dual-polarized antennas and the antennas in the direction of −45 degrees among the second and third pairs of dual-polarized antennas into a first port and virtualizing the antennas in the direction of −45 degrees among the first and fourth pairs of dual-polarized antennas and the antennas in the direction of +45 degrees among the second and third pairs of dual-polarized antennas into a second port,

wherein as broadcast weights of the 4 antennas of the first port, the weight of one of the antennas is +1 and the weights of the remaining three antennas are −1, or the weight of one of the antennas is −1 and the weights of the remaining three antennas are +1, and

as broadcast weights of the 4 antennas of the second port, the weight of one of the antennas is +1 and the weights of the remaining three antennas are −1, or the weight of one of the antennas is −1 and the weights of the remaining three antennas are +1; and

the base station transmitting a downlink control signal through the first port and the second port.

The base station is a Long Term Evolution, LTE, Time Division Duplex, TDD, base station or an LTE-A TDD base station or an LTE Frequency Division Duplex, FDD, base station or an LTE-A FDD base station.

A method of transmitting a downlink control channel on 8 antennas includes:

for the 8 antennas used by a base station for downlink transmission, virtualizing the antennas in the direction of +45 degrees among the first, second, third and fourth pairs of dual-polarized antennas into a first port and virtualizing the antennas in the direction of −45 degrees among the first, second, third and fourth pairs of dual-polarized antennas into a second port,

wherein as broadcast weights of the 4 antennas of the first port, the weight of one of the antennas is +1 and the weights of the remaining three antennas are −1, or the weight of one of the antennas is −1 and the weights of the remaining three antennas are +1, and

as broadcast weights of the 4 antennas of the second port, the weight of one of the antennas is +1 and the weights of the remaining three antennas are −1, or the weight of one of the antennas is −1 and the weights of the remaining three antennas are +1; and

the base station transmitting a downlink control signal through the first port and the second port.

The base station is a Long Term Evolution, LTE, Time Division Duplex, TDD, base station or an LTE-A TDD base station or an LTE Frequency Division Duplex, FDD, base station or an LTE-A FDD base station.

An apparatus for transmitting a downlink control channel on 8 antennas includes:

a port grouping module configured, for the 8 antennas used by a base station for downlink transmission, to virtualize the first and third pairs of dual-polarized antennas into a first port and virtualize the second and fourth pairs of dual-polarized antennas into a second port, wherein broadcast weights of the 4 antennas of the first port satisfy that the weight of one of the antennas is +1 and the weights of the remaining three antennas are −1, or the weight of one of the antennas is −1 and the weights of the remaining three antennas are +1; and broadcast weights of the 4 antennas of the second port satisfy that the weight of one of the antennas is +1 and the weights of the remaining three antennas are −1, or the weight of one of the antennas is −1 and the weights of the remaining three antennas are +1; and

a downlink control signal transmitting module configured to transmit a downlink control signal through the first port and the second port obtained by the port grouping module.

The apparatus is located on a Long Term Evolution, LTE, Time Division Duplex, TDD, base station or on an LTE-A TDD base station or on an LTE Frequency Division Duplex, FDD, base station or on an LTE-A FDD base station.

An apparatus for transmitting a downlink control channel on 8 antennas includes:

a port grouping module configured, for the 8 antennas used by a base station for downlink transmission, to virtualize the first and fourth pairs of dual-polarized antennas into a first port and virtualize the second and third pairs of dual-polarized antennas into a second port, wherein as broadcast weights of the 4 antennas of the first port, the weight of one of the antennas is +1 and the weights of the remaining three antennas are −1, or the weight of one of the antennas is −1 and the weights of the remaining three antennas are +1; and as broadcast weights of the 4 antennas of the second port, the weight of one of the antennas is +1 and the weights of the remaining three antennas are −1, or the weight of one of the ante as is −1 and the weights of the remaining three antennas are +1; and

a downlink control signal transmitting module configured to transmit a downlink control signal through the first port and the second port obtained by the port grouping module.

The apparatus is located on a Long Term Evolution, LTE, Time Division Duplex, TDD, base station or on an LTE-A TDD base station or on an LTE Frequency Division Duplex, FDD, base station or on an LTE-A MD base station.

An apparatus for transmitting a downlink control channel on 8 antennas includes:

for the 8 antennas used by a base station for downlink transmission, to virtualize the antennas in the direction of +45 degrees among the first and second pairs of dual-polarized antennas and the antennas in the direction of −45 degrees among the third and fourth pairs of dual-polarized antennas into a first port and virtualize the antennas in the direction of −45 degrees among the first and second pairs of dual-polarized antennas and the antennas in the direction of +45 degrees among the third and fourth pairs of dual-polarized antennas into a second port, wherein as broadcast weights of the 4 antennas of the first port, the weight of one of the antennas is +1 and the weights of the remaining three antennas are −1, or the weight of one of the antennas is −1 and the weights of the remaining three antennas are +1; and as broadcast weights of the 4 antennas of the second port, the weight of one of the antennas is +1 and the weights of the remaining three antennas are −1, or the weight of one of the antennas is −1 and the weights of the remaining three antennas are +1; and

a downlink control signal transmitting module configured to transmit a downlink control signal through the first port and the second port obtained by the port grouping module.

The apparatus is located on a Long Terra Evolution, LTE, Time Division Duplex, TDD, base station or on an LTE-A TDD base station or on an LIT Frequency Division Duplex, FDD, base station or on an LTE-A FDD base station.

An apparatus for transmitting a downlink control channel on 8 antennas includes:

a port grouping module is configured, for the 8 antennas used by abuse station for downlink transmission, to virtualize the antennas in the direction of +45 degrees among the first and third pairs of dual-polarized antennas and the antennas in the direction of −45 degrees among the second and fourth pairs of dual-polarized antennas into a first port and virtualize the antennas in the direction of −45 degrees among the first and third pairs of dual-polarized antennas and the antennas in the direction of +45 degrees among the second and fourth pairs of dual-polarized antennas into a second port, wherein as broadcast weights of the 4 antennas of the first port, the weight of one of the antennas is +1 and the weights of the remaining three antennas are −1, or the weight of one of the antennas is −1 and the weights of the remaining three antennas are +1; and as broadcast weights of the 4 antennas of the second port, the weight of one of the antennas is +1 and the weights of the remaining three antennas are −1, or the weight of one of the antennas is −1 and the weights of the remaining three antennas are +1; and

a downlink control signal transmitting module configured to transmit a downlink control signal through the first port and the second port obtained by the port grouping module.

The apparatus is located on a Long Term Evolution, LTE, Time Division Duplex, TDD, base station or on an LTE-A TDD base station or on an LTE Frequency Division Duplex, FDD, base station or on an LTE-A FDD base station.

An apparatus for transmitting a downlink control channel on 8 antennas includes:

a port grouping module is configured, for the 8 antennas used by a base station for downlink transmission, to virtualize the antennas in the direction of +45 degrees among the first and fourth pairs of dual-polarized antennas and the antennas in the direction of −45 degrees among the second and third pairs of dual-polarized antennas into a first port and virtualize the antennas in the direction of −45 degrees among the first and fourth pairs of dual-polarized antennas and the antennas in the direction of +45 degrees among the second and third pairs of dual-polarized antennas into a second port, wherein as broadcast weights of the 4 antennas of the first port, the weight of one of the antennas is +1 and the weights of the remaining three antennas are −1, or the weight of one of the antennas is −1 and the weights of the remaining three antennas are +1; and as broadcast weights of the 4 antennas of the second port, the weight of one of the antennas is +1 and the weights of the remaining three antennas are −1, or the weight of one of the antennas is −1 and the weights of the remaining three antennas are +1; and

a downlink control signal transmitting module configured to transmit a downlink control signal through the first port and the second port obtained by the port grouping module.

The apparatus is located on a Long Term Evolution, LTE, Time Division Duplex, TDD, base station or on an LTE-A TDD base station or on an LTE Frequency Division Duplex, FDD, base station or on an LTE-A FDD base station.

An apparatus for transmitting a downlink control channel on 8 antennas includes:

a port grouping module is configured, for the 8 antennas used by a base station for downlink transmission, to virtualize the antennas in the direction of +45 degrees among the first, second, third and fourth pairs of dual-polarized antennas into a first port and virtualize the antennas in the direction of −45 degrees among the first, second, third and fourth pairs of dual-polarized antennas into a second port, wherein as broadcast weights of the 4 antennas of the first port, the weight of one of the antennas is +1 and the weights of the remaining three antennas are −1, or the weight of one of the antennas is −1 and the weights of the remaining three antennas are +1; and as broadcast weights of the 4 antennas of the second port, the weight of one of the antennas is +1 and the weights of the remaining three antennas are −1, or the weight of one of the antennas is −1 and the weights of the remaining three antennas are +1; and

a downlink control signal transmitting module configured to transmit a downlink control signal through the first port and the second port obtained by the port grouping module.

The apparatus is located on a Long Term Evolution, LTE, Time Division Duplex, TDD, base station or on an LTE-A TDD base station or on an LTE Frequency Division Duplex, FDD, base station or on an LTE-A FDD base station.

The invention can extend a coverage area of a downlink control channel of a base station with 8 antennas as a whole in comparison with the prior art,

### BRIEF DESCRIPTION OF THE DRAWINGS

In order to further elucidate technical solutions of embodiments of the invention or in the prior art, the drawings to be used in a description of the embodiments or the prior art will be introduced briefly, and obviously the drawings to be described below illustrate only some of the embodiments of the invention, and those ordinarily skilled in the art can further derive from these drawings other drawings without any inventive effort,

FIG. 1 is a schematic diagram of the existing TD-LTE base station transmitting a downlink control channel in the weighted broadcast scheme;

FIG. 2 is a flow chart of a method of a base station with 8 antennas to transmit a downlink control channel according to a first embodiment of the invention;

FIG. 3 is a schematic diagram of a scheme of the base station with 8 antennas to transmit a downlink control channel according to the first embodiment of the invention;

FIG. 4 is a flow chart of a method of a base station with 8 antennas to transmit a downlink control channel according to a second embodiment of the invention;

FIG. 5 is a schematic diagram of a scheme of the base station with 8 antennas to transmit a downlink control channel according to the second embodiment of the invention;

FIG. 6 is a flow chart of a method of a base station with 8 antennas to transmit a downlink control channel according to a third embodiment of the invention;

FIG. 7 is a schematic diagram of a scheme of the base station with 8 antennas to transmit a downlink control channel according to the third embodiment of the invention;

FIG. 8 is a flow chart of a method of a base station with 8 antennas to transmit a downlink control channel according to a fourth embodiment of the invention;

FIG. 9 is a schematic diagram of a scheme of the base station with 8 antennas to transmit a downlink control channel according to the fourth embodiment of the invention;

FIG. 10 is a flow chart of a method of a base station with 8 antennas to transmit a downlink control channel according to a fifth embodiment of the invention;

FIG. 11 is a schematic diagram of a scheme of the base station with 8 antennas to transmit a downlink control channel according to the fifth embodiment of the invention;

FIG. 12 is a flow chart of a method of a base station with 8 antennas to transmit a downlink control channel according to a sixth embodiment of the invention;

FIG. 13 is a schematic diagram of a scheme of the base station with 8 antennas to transmit a downlink control channel according to the sixth embodiment of the invention;

FIG. 14 is a schematic diagram of components of an apparatus for transmitting a downlink control channel on 8 antennas according to the first embodiment of the invention; and

FIG. 15 is a comparison diagram of simulation graphs of the first to sixth embodiments of the invention and the existing weighted broadcast scheme.

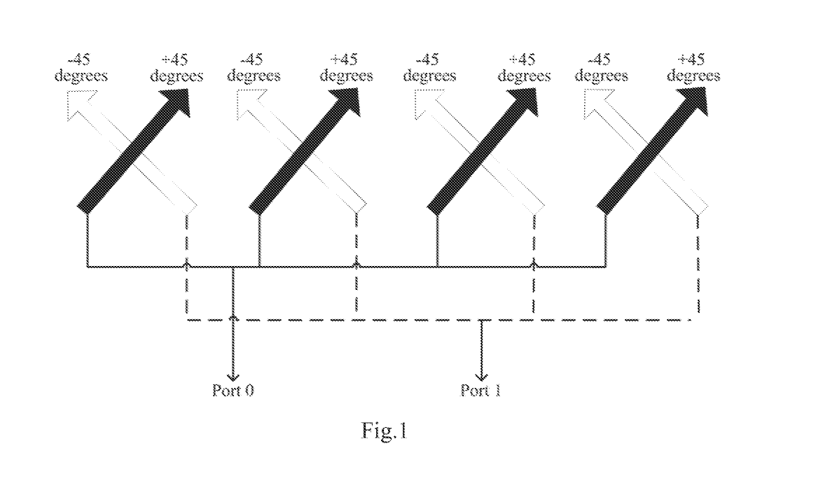

### DETAILED DESCRIPTION OF THE EMBODIMENTS

The invention will be further detailed below with o the drawings and embodiments thereof.

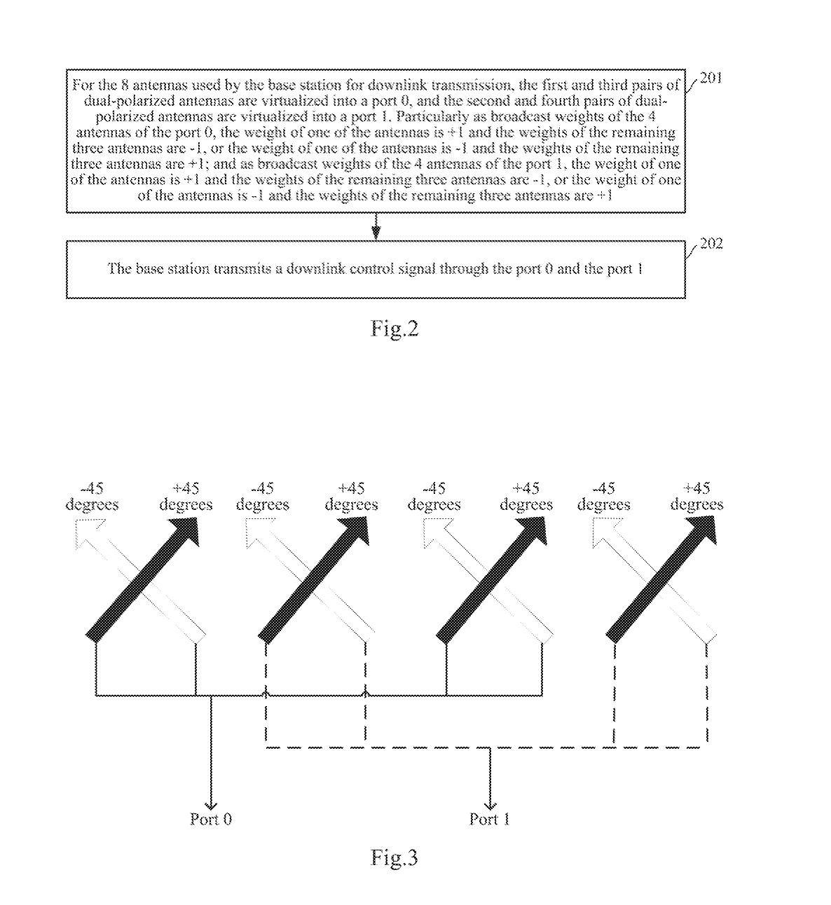

FIG. 2 is a flow chart of a method of a base station with 8 antennas to transmit a downlink control channel according to a first embodiment of the invention, and as illustrated in FIG. 2, particular steps thereof are as follows:

Step 201: for the 8 antennas used by the base station for downlink transmission, the first and third pairs of dual-polarized antennas are virtualized into a port 0, and the second and fourth pairs of dual-polarized antennas are virtualized into a port 1. Particularly as broadcast weights of the 4 antennas of the port 0, the weight of one of the antennas is +1 and the weights of the remaining three antennas are −1, or the weight of one of the antennas is −1 and the weights of the remaining three antennas are +1; and as broadcast weights of the 4 antennas of the port 1, the weight of one of the antennas is +1 and the weights of the remaining three antennas are −1, or the weight of one of the antennas is −1 and the weights of the remaining three antennas are +1.

is a schematic diagram of a scheme of the base station with 8 antennas to transmit a downlink control channel according to the first embodiment of the invention.

Step 202: the base station transmits a downlink control signal through the port 0 and the port 1.

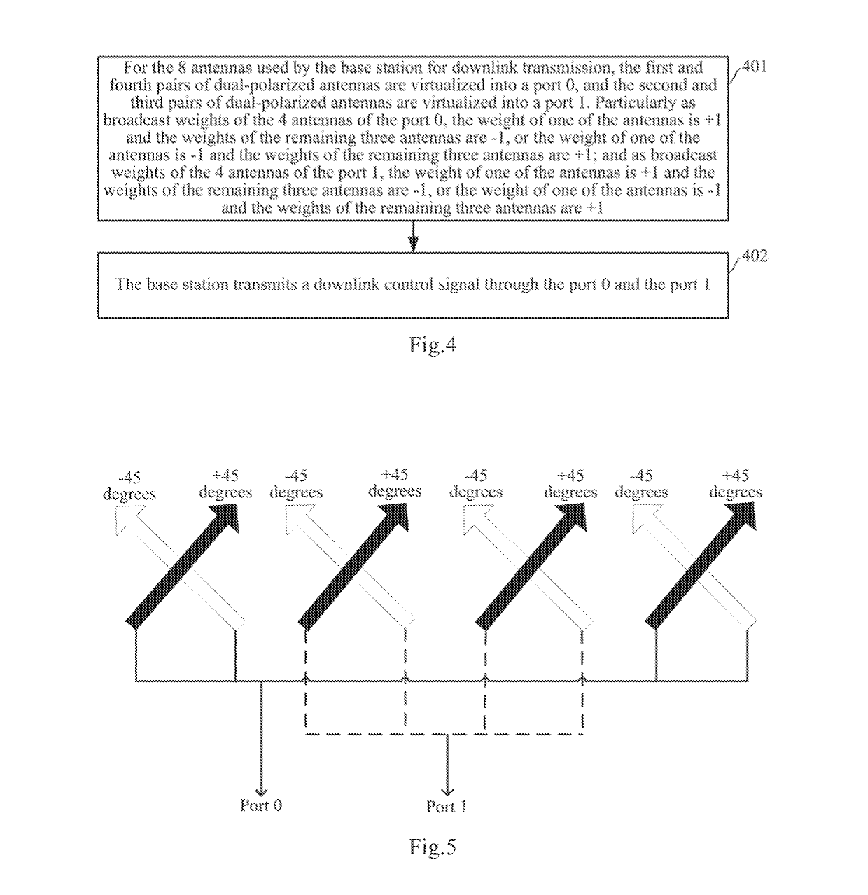

FIG. 4 is a flow chart of a method of a base station with 8 antennas to transmit a downlink control channel according to a second embodiment of the invention, and as illustrated in FIG. 4, particular steps thereof are as follows:

Step 401: for the 8 antennas used by the base station for downlink transmission, the first and fourth pairs of dual-polarized antennas are virtualized into a port 0, and the second and third pairs of dual-polarized antennas are virtualized into a port 1. Particularly as broadcast weights of the 4 antennas of the port 0, the weight of one of the antennas is +1 and the weights of the remaining three antennas are −1, or the weight of one of the antennas is −1 and the weights of the remaining three antennas are +1; and as broadcast weights of the 4 antennas of the port 1, the weight of one of the antennas is +1 and the weights of the remaining three antennas are −1, or the weight of one of the antennas is −1 and the weights of the remaining three antennas are +1.

FIG. 5 is a schematic diagram of a scheme of the base station with 8 antennas to transmit a downlink control channel according to the second embodiment of the invention.

Step 402: the base station transmits a downlink control signal through the port 0 and the port 1.

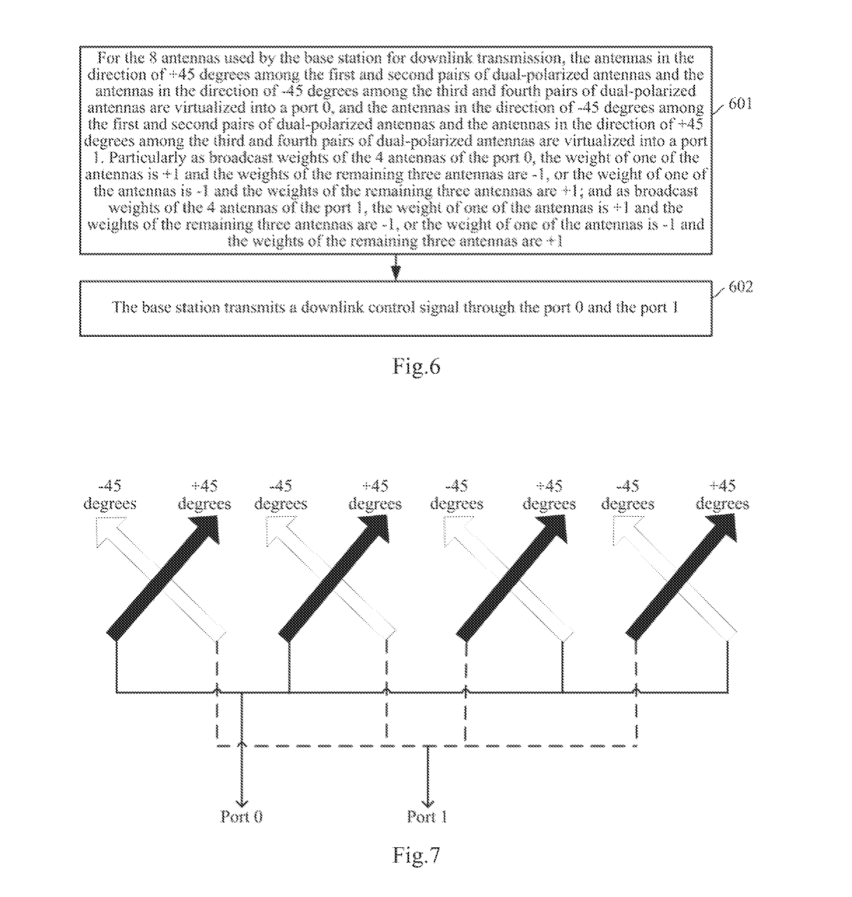

FIG. 6 is a flow chart of a method of a base station with 8 antennas to transmit a downlink control channel according to a third embodiment of the invention, and as illustrated in FIG. 6, particular steps thereof are as follows:

Step 601: for the 8 antennas used by the base station for downlink transmission, the antennas in the direction of +45 degrees among the first and second pairs of dual-polarized antennas and the antennas in the direction of −45 degrees among the third and fourth pairs of dual-polarized antennas are virtualized into a port 0, and the antennas in the direction of −45 degrees among the first and second pairs of dual-polarized antennas and the antennas in the direction of +45 degrees among the third and fourth pairs of dual-polarized antennas are virtualized into a port 1. Particularly as broadcast weights of the 4 antennas of the port 0, the weight of one of the antennas is +1 and the weights of the remaining three antennas are −1, or the weight of one of the antennas is −1 and the weights of the remaining three antennas are +1; and as broadcast weights of the 4 antennas of the port 1, the weight of one of the antennas is +1 and the weights of the remaining three antennas are −1, or the weight of one of the antennas is −1 and the weights of the remaining three antennas are +1.

FIG. 7 is a schematic diagram of a scheme of the base station with 8 antennas to transmit a downlink control channel according to the third embodiment of the invention.

Step 602: the base station transmits a downlink control signal through the port 0 and the port 1.

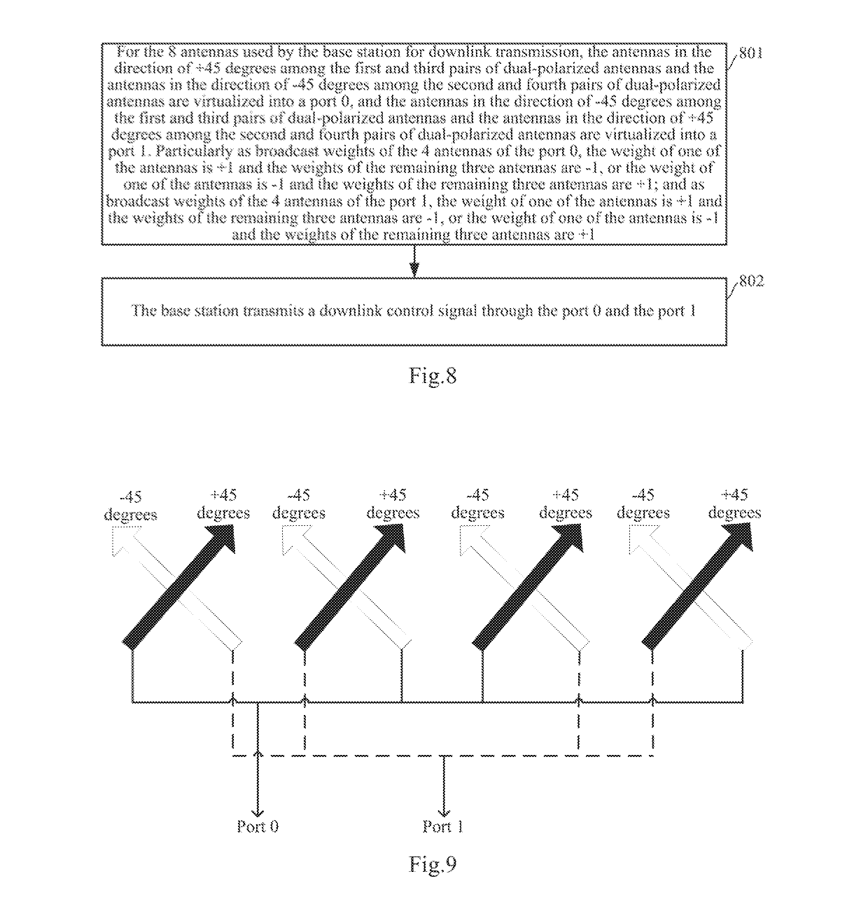

FIG. 8 is a flow chart of a method of a base station with 8 antennas to transmit a downlink control channel according to a fourth embodiment of the invention, and as illustrated in FIG. 8, particular steps thereof are as follows:

Step 801: tier the 8 antennas used by the base station tier downlink transmission, the antennas in the direction of +45 degrees among the first and third pairs of dual-polarized antennas and the antennas in the direction of −45 degrees among the second and fourth pairs of dual-polarized antennas are virtualized into a port 0, and the antennas in the direction of −45 degrees among the first and third pairs of dual-polarized antennas and the antennas in the direction of +45 degrees among the second and fourth pairs of dual-polarized antennas are virtualized into a port I Particularly as broadcast weights of the 4 antennas of the port 0, the weight of one of the antennas is +11 and the weights of the remaining three antennas are −1, or the weight of one of the antennas is −1 and the weights of the remaining three antennas are +1; and as broadcast weights of the 4 antennas of the port 1, the weight of one of the antennas is +1 and the weights of the remaining three antennas are −1, or the weight of one of the antennas is −1 and the weights of the remaining three antennas are +1.

FIG. 9 is a schematic diagram of a scheme of the base station with 8 antennas to transmit a downlink control channel according to the fourth embodiment of the invention,

Step 802: the base station transmits a downlink control signal through the port 0 and the port 1.

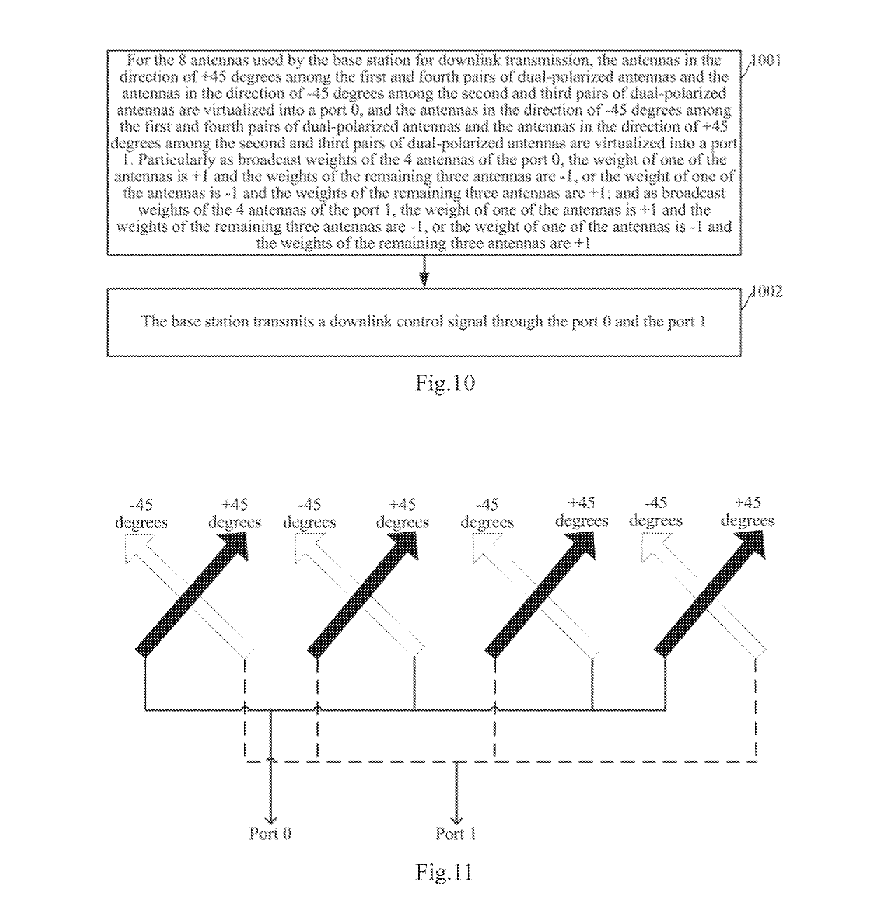

is a flow chart of a method of a base station with 8 antennas to transmit a downlink control channel according to a fifth embodiment of the invention, and as illustrated in FIG. 10, particular steps thereof are as follows:

Step 1001: for the 8 antennas used by the base station for downlink transmission, the antennas in the direction of +45 degrees among the first and fourth pairs of dual-polarized antennas and the antennas in the direction of −45 degrees among the second and third pairs of dual-polarized antennas are virtualized into a port 0, and the antennas in the direction of −45 degrees among the first and fourth pairs of dual-polarized antennas and the antennas in the direction of +45 degrees among the second and third pairs of dual-polarized antennas are virtualized into a port 1. Particularly as broadcast weights of the 4 antennas of the port 0, the weight of one of the antennas is +1 and the weights of the remaining three antennas are −1 or the weight of one of the antennas is −1 and the weights of the remaining three antennas are +1; and as broadcast weights of the 4 antennas of the port 1, the weight of one of the antennas is +1 and the weights of the remaining three antennas are −1, or the weight of one of the antennas is −1 and the weights of the remaining three antennas are +1.

FIG. 11 is a schematic diagram of a scheme of the base station with 8 antennas to transmit a downlink control channel according to the fifth embodiment of the invention.

Step 1002: the base station transmits a downlink control signal through the port 0 and the port 1.

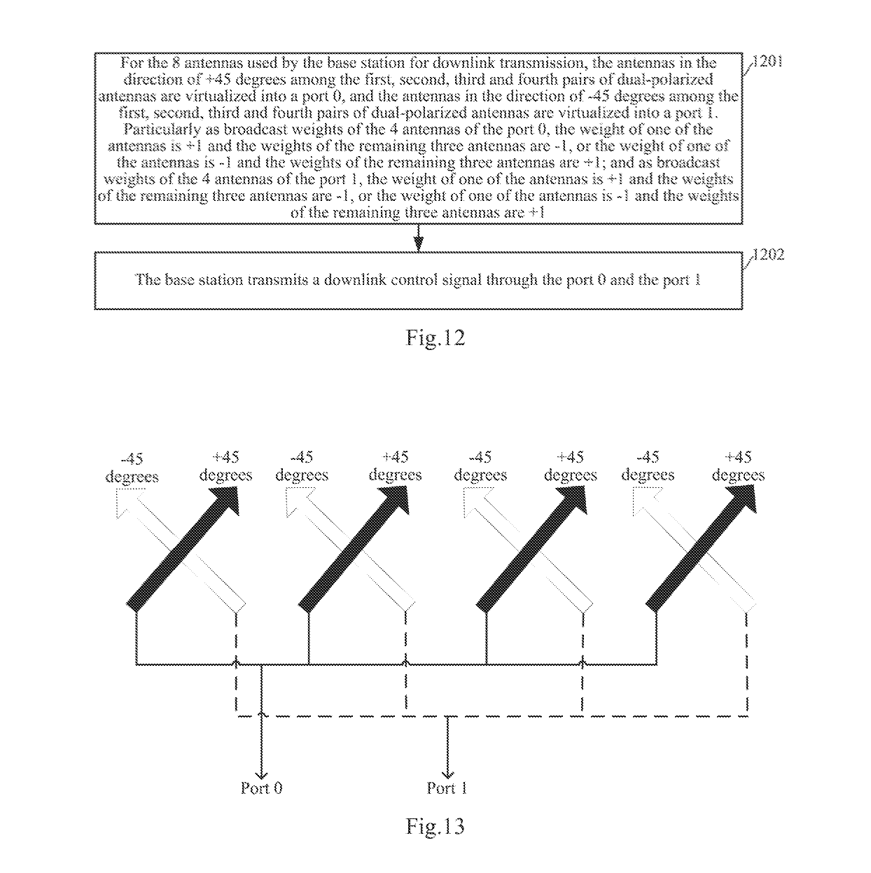

FIG. 12 is a flow chart of a method of a base station with 8 antennas to transmit a downlink control channel according to a sixth embodiment of the invention, and as illustrated in FIG. 12, particular steps thereof are as follows:

Step 1201: for the 8 antennas used by the base station for downlink transmission, the antennas in the direction of +45 degrees among the first, second, third and fourth pairs of dual-polarized antennas are virtualized into a port 0, and the antennas in the direction of −45 degrees among the first, second, third and fourth pairs of dual-polarized antennas are virtualized into a port 1. Particularly as broadcast weights of the 4 antennas of the port 0, the weight of one of the antennas is +1 and the weights of the remaining three antennas are −1, or the weight of one of the antennas is −1 and the weights of the remaining three antennas are +1; and as broadcast weights of the 4 antennas of the port 1, the weight of one of the antennas is +1 and the weights of the remaining three antennas are −1, or the weight of one of the antennas is −1 and the weights of the remaining three antennas are +1.

FIG. 13 is a schematic diagram of a scheme of the base station with 8 antennas to transmit a downlink control channel according to the sixth embodiment of the invention.

Stop 1202: the base station transmits a downlink control signal through the port 0 and the port 1.

It shall be noted that for the port 0 and the port 1 in any of the embodiments of the invention, the weights of the 4 antennas of these two ports may be the same or may be different. For example, for the port 1, the weights of the 4 antennas of the port 1 may be exactly the same as or may be different from the weights of the 4 antennas of the port 0.

The base station in the first to sixth embodiment of the invention can be an LTE TDD base station or an LTE-A TDD base station or an LTE FDD base station or an LTE-A FDD base station.

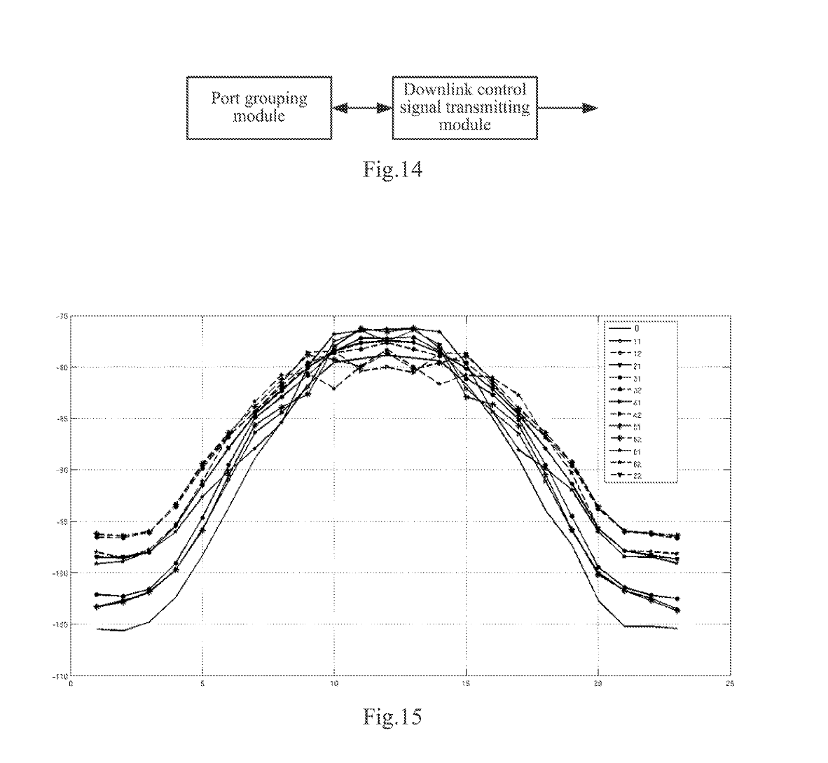

FIG. 14 is a schematic diagram of components of an apparatus for transmitting a downlink control channel on 8 antennas according to the first embodiment of the invention, and as illustrated FIG. 14, it generally includes a port grouping module and a downlink control signal transmitting module, where:

The port grouping module is configured, for the 8 antennas used by a base station for downlink transmission, to virtualize the first and third pairs of dual-polarized antennas into a first port and virtualize the second and fourth pairs of dual-polarized antennas into a second port, where broadcast weights of the 4 antennas of the first port satisfy that the weight of one of the antennas is +1. and the weights of the remaining three antennas are −1, or the weight of one of the antennas is −1 and the weights of the remaining three antennas are +1; and broadcast weights of the 4 antennas of the second port satisfy that the weight of one of the antennas is +1 and the weights of the remaining three antennas are −1, or the weight of one of the antennas is −1 and the weights of the remaining three antennas are +1; and to record correspondences between numbers of the respective ports and identifiers of the antennas and record the broadcast weights of the respective antennas included in the respective ports.

The downlink control signal transmitting module is configured to transmit a downlink control signal through the first port and the second port according to the correspondences between the numbers of respective ports and the identifiers of the antennas and the broadcast weights of the respective antennas included in the respective ports recorded by the port grouping module.

The apparatus illustrated in FIG. 14 can be located on an um TDD base station or on an LTE-A TDD base station or on an LTE FDD base station or on an LTE-A FDD base station.

There will be given below components of an apparatus for transmitting a downlink control channel on 8 antennas according to the second embodiment of the invention, and it generally includes a port grouping module and a downlink control signal transmitting module, where:

The port grouping module is configured, for the 8 antennas used by a base station for downlink transmission, to virtualize the first and fourth pairs of dual-polarized antennas into a first port and virtualize the second and third pairs of dual-polarized antennas into a second port, where as broadcast weights of the 4 antennas of the first port, the weight of one of the antennas is +1 and the weights of the remaining three antennas are −1, or the weight of one of the antennas is −1 and the weights of the remaining three antennas are +1; and as broadcast weights of the 4 antennas of the second port, the weight of one of the antennas is +1 and the weights of the remaining three antennas are −1, or the weight of one of the antennas is −1 and the weights of the remaining three antennas are +1; and to record correspondences between numbers of the respective ports and identifiers of the antennas and record the broadcast weights of the respective antennas included in the respective ports.

The downlink control signal transmitting module is configured to transmit a downlink control signal through the first port and the second pod according to the correspondences between the numbers of respective ports and the identifiers of the antennas and the broadcast weights of the respective antennas included in the respective ports recorded by the port grouping module.

The apparatus according to the second embodiment of the invention can be located on an LTE TDD base station or on an LTE-A TDD base station or on an LTE FDD base station or on an LTE-A FDD base station.

There will be given below components of an apparatus for transmitting a downlink control channel on 8 antennas according to the third embodiment of the invention, and it generally includes a port grouping module and a downlink control signal transmitting module, where:

The port grouping module is configured, for the 8 antennas used by a base station for downlink transmission, to virtualize the antennas in the direction of +45 degrees among the first and second pairs of dual-polarized antennas and the antennas in the direction of −45 degrees among the third and fourth pairs of dual-polarized antennas into a first port and virtualize the antennas in the direction of −45 degrees among the first and second pairs of dual-polarized. antennas and the antennas in the direction of +45 degrees among the third and fourth pairs of dual-polarized antennas into a second port, where as broadcast weights of the 4 antennas of the first port, the weight of one of the antennas is +1 and the weights of the remaining three antennas are −1, or the weight of one of the antennas is −1 and the weights of the remaining three antennas are +1; and as broadcast weights of the 4 antennas of the second port, the weight of one of the antennas is +1 and the weights of the remaining three antennas are −1, or the weight of one of the antennas is −1 and the weights of the remaining three antennas are +1; and to record correspondences between numbers of the respective ports and identifiers of the antennas and record the broadcast weights of the respective antennas included in the respective ports.

The downlink control signal transmitting module is configured to transmit a downlink control signal through the first port and the second port according to the correspondences between the numbers of respective ports and the identifiers of the antennas and the broadcast weights of the respective antennas included in the respective ports recorded by the port grouping module.

The apparatus according to the third embodiment of the invention can be located on an LTE TDD base station or on an LTE-A TDD base station or on an LTE FDD base station or on an LTE-A FDD base station.

There will be given below components of an apparatus for transmitting a downlink control channel on 8 antennas according to the fourth embodiment of the invention, and it generally includes a port grouping module and a downlink control signal transmitting module, where:

The port grouping module is configured, for the 8 antennas used by a base station for downlink transmission, to virtualize the antennas in the direction of +45 degrees among the first and third pairs of dual-polarized antennas and the antennas in the direction of −45 degrees among the second and fourth pairs of dual-polarized antennas into a first port and virtualize the antennas in the direction of −45 degrees among the first and third pairs of dual-polarized antennas and the antennas in the direction of +45 degrees among the second and fourth pairs of dual-polarized antennas into a second port, where as broadcast weights of the 4 antennas of the first port, the weight of one of the antennas is +1 and the weights of the remaining three antennas are −1, or the weight of one of the antennas is −1 and the weights of the remaining three antennas are +1; and as broadcast weights of the 4 antennas of the second port, the weight of one of the antennas is +1 and the weights of the remaining three antennas are −1, or the weight of one of the antennas is −1 and the weights of the remaining three antennas are +1; and to record correspondences between numbers of the respective ports and identifiers of the antennas and record the broadcast weights of the respective antennas included in the respective ports.

The downlink control signal transmitting module is configured to transmit a downlink control signal through the first port and the second port according to the correspondences between the numbers of respective ports and the identifiers of the antennas and the broadcast weights of the respective antennas included in the respective ports recorded by the port grouping module.

The apparatus according to the fourth embodiment of the invention can be located on an LTE TDD base station or on an LTE-A TDD base station or on an LTE MD base station or on an LTE-A FDD base station.

There will be given below components of an apparatus for transmitting a downlink control channel on 8 antennas according to the fifth embodiment of the invention, and it generally includes a port grouping module and a downlink control signal transmitting module,

The port grouping module is configured, for the 8 antennas used by a base station for downlink transmission, to virtualize the antennas in the direction of +45 degrees among the first and fourth pairs of dual-polarized antennas and the antennas in the direction of −45 degrees among the second and third pairs of dual-polarized antennas into a first port and virtualize the antennas in the direction of −45 degrees among the first and fourth pairs of dual-polarized antennas and the antennas in the direction of +45 degrees among the second and third pairs of dual-polarized antennas into a second port, where as broadcast weights of the 4 antennas of the first port, the weight of one of the antennas is +1 and the weights of the remaining three antennas are −1, or the weight of one of the antennas is −1 and the weights of the remaining three antennas are +1; and as broadcast weights of the 4 antennas of the second port, the weight of one of the antennas is +1 and the weights of the remaining three antennas are −1, or the weight of one of the antennas is −1 and the weights of the remaining three antennas are +1; and to record correspondences between numbers of the respective ports and identifiers of the antennas and record the broadcast weights of the respective antennas included in the respective ports.

The downlink control signal transmitting module is configured to transmit a downlink control signal through the first port and the second port according to the correspondences between the numbers of respective ports and the identifiers of the antennas and the broadcast weights of the respective antennas included in the respective ports recorded by the port grouping module.

The apparatus according to the fifth embodiment of the invention can be located on an LTE TDD base station or on an LTE-A TDD base station or on an LTE FDD base station or on an LTE-A FDD base station.

There will be given below components of an apparatus for transmitting a downlink control channel on 8 antennas according to the sixth embodiment of the invention, and it generally includes a port grouping module and a downlink control signal transmitting module, where:

The port grouping module is configured, for the 8 antennas used by a base station for downlink transmission, to virtualize the antennas in the direction of +45 degrees among the first, second, third and fourth pairs of dual-polarized antennas into a first port and virtualize the antennas in the direction of −45 degrees among the first, second, third and fourth pairs of dual-polarized antennas into a second port, where as broadcast weights of the 4 antennas of the first port, the weight of one of the antennas is +1 and the weights of the remaining three antennas are −1, or the weight of one of the antennas is −1 and the weights of the remaining three antennas are +1; and as broadcast weights of the 4 antennas of the second port, the weight of one of the antennas is +1 and the weights of the remaining three antennas are −1, or the weight of one of the antennas is −1 and the weights of the remaining three antennas are +1; and to record correspondences between numbers of the respective ports and identifiers of the antennas and record the broadcast weights of the respective antennas included in the respective ports.

The downlink control signal transmitting module is configured to transmit a downlink control signal through the first port and the second port according to the correspondences between the numbers of respective ports and the identifiers of the antennas and the broadcast weights of the respective antennas included in the respective ports recorded by the port grouping module.

The apparatus according to the sixth embodiment of the invention can be located on an LTE TDD base station or on an LTE-A TDD base station or on an LTE FDD base station or on LTE-A FDD base station.

Experiments have demonstrated that the method of transmitting a downlink control channel on 8 antennas according to the invention can enable the performance of the downlink control channel to reach and even exceed the performance of a downlink control channel on 2 antennas of an LTE FDD base station.

The methods according to the six embodiments of the invention and the existing weighted broadcast method will be compared in the same simulation scenario as given below:

A simulation condition is as follows:

The simulation scenario is a 2D antenna scenario 1 of the Third Generation Partnership Project (3GPP Scenario 1-2D). A base station is assumed as a TD-LTE base station with downlink transmission on 8 (4 pairs of) dual-polarized antennas with two adjacent pairs of antennas being spaced at an interval of half a wavelength; and a User Equipment (UE) is assumed with 2 homo-polarized antennas spaced at an interval of half a wavelength.

No consideration of the influence of shadow fading is assumed.

A simulation process is as follows:

A TD-LTE base station is selected, and at a distance of 100 meters from the TD-LTE base station, there is a corresponding LTE spaced at each interval of 10 degrees from a major lobe to each side of an antenna in a sector of the TD-LTE base station. Considering rapid fading, the magnitudes of the power of a downlink control signal received on two antennas of each UE from each port of the TD-LTE base station, i.e., the port 0 and the port 1, are recorded respectively for each of the schemes including the six schemes according to the first to sixth embodiments of the invention and the existing weighted broadcast scheme. The sum of the power of the downlink control signal received on two antennas of each UE over a predetermined period of time from each port of the TD-LTE base station, i.e., the port 0 and the port 1, is linearly averaged for each of the schemes.

FIG. 15 illustrates a comparison diagram of simulation results, where the abscissa is scaled in unit of 10 degrees, and since there is a corresponding UE spaced at each interval of 10 degrees from a major lobe to each side of an antenna in a sector of the TD-LTE base station, each integer point on the abscissa in FIG. 15 represents a UE, and there are 25 UEs in total, where an integer point closer to the center is located closer to the major lobe of the antenna; and the ordinate represents the linearly averaged sum in unit of dbm of the power of the downlink control signal received on two antennas of a UE from the port 0 of the TD-LTE base station over a predetermined period of time.

Corresponding schemes are indicated at the top right corner of FIG. 15, where:

Scheme 0: the existing weighted broadcast scheme, that is, the port 0 is virtually consisted of 4 antennas in the direction of +45 degrees, and the port 1 is virtually consisted of 4 antennas in the direction of −45 degrees; and broadcast weights of the 4 antennas of the port 0 are [−0.6230-0.0025j, 1.0, 1.0, 0.2986-0.0020j], and broadcast weights of the 4 antennas of the port 1 are also [−0.6230-0.0025j, 1.0, 1.0, 0.2986-0.0020j].

Scheme 11: the first embodiment of the invention, where weights of 4 antennas of each of the ports 0 and 1 are [1, 1, 1, −1].

Scheme 12: the first embodiment of the invention, where weights of 4 antennas of each of the ports 0 and 1 are [1, −1, 1, 1].

Scheme 21: the second embodiment of the invention, where weights of 4 antennas of each of the ports 0 and 1 are [1, 1, 1, −1],

Scheme 22: the second embodiment of the invention, where weights of 4 antennas of each of the ports 0 and 1 are [1,−1, 1, 1].

Scheme 31: the third embodiment of the invention, where weights of 4 antennas of each of the ports 0 and 1 are [1, 1, 1, −1].

Scheme 32: the third embodiment of the invention, where weights of 4 antennas of each of the ports 0 and 1 are [1, −1, 1, 1].

Scheme 41: the fourth embodiment of the invention, where weights of 4 antennas of each of the ports 0 and I are [1, 1, 1, −1].

Scheme 42: the fourth embodiment of the invention, where weights of 4 antennas of each of the ports 0 and 1 are [1, −1, 1, 1].

Scheme 51: the fifth embodiment of the invention, where weights of 4 antennas of each of the ports 0 and 1 are [1, 1, 1, −1].

Scheme 52: the fifth embodiment of the invention, where weights of 4 antennas of each of the ports 0 and 1 are [1, −1, 1, 1].

Scheme 61: the sixth embodiment of the invention, where weights of 4 antennas of each of the ports 0 and 1 are [1, 1, 1, −1].

Scheme 62: the sixth embodiment of the invention, where weights of 4 antennas of each of the ports 0 and 1 are [1, −1, 1, 1].

As can be apparent from FIG. 15, the six schemes according to the embodiments of the invention have better overall downlink control performance as a whole than the existing weighted broadcast scheme, although the existing weighted broadcast scheme has better downlink control performance than the six schemes according to the embodiments of the invention around the major lobe of the antenna of a sector of the TM-LTE base station.

The foregoing description is merely illustrative of the preferred embodiments of the invention but not intended to limit the invention, and any modifications, equivalent substitutions, adaptations, etc., made without departing from the spirit and principle of the invention shall be encompassed in the claimed scope of the invention.

1. A method of transmitting a downlink control channel on 8 antennas, comprising:
for the 8 antennas used by a base station for downlink transmission, virtualizing 4 antennas among the 8 antennas into a first port and virtualizing the other 4 antennas among the 8 antennas into a second port,
wherein broadcast weights of the 4 antennas of the first port satisfy that the weight of one of the antennas is +1 and the weights of the remaining three antennas are −1, or the weight of one of the antennas is −1 and the weights of the remaining three antennas are +1, and
broadcast weights of the 4 antennas of the second port satisfy that the weight of one of the antennas is +1 and the weights of the remaining three antennas are −1, or the weight of one of the antennas is −1 and the weights of the remaining three antennas are +1; and
the base station transmitting a downlink control signal through the first port and the second port.

2. The method of claim 1, wherein the first and third pairs of dual-polarized antennas among the 8 antennas are virtualized into the first port and the second and fourth pairs of dual-polarized antennas among the 8 antennas are virtualized into the second.

3. The method of claim 1, wherein
the first and fourth pairs of dual-polarized antennas among the 8 antennas are virtualized into the first port and the second and third pairs of dual-polarized antennas among the 8 antennas are virtualized into the second port.

4. (canceled)

5. The method of claim 1, wherein
the antennas in the direction of +45 degrees among the first and second pairs of dual-polarized antennas of the 8 antennas and the antennas in the direction of −45 degrees among the third and fourth pairs of dual-polarized antennas of the 8 antennas are virtualized into the first port and the antennas in the direction of −45 degrees among the first and second pairs of dual-polarized antennas of the 8 antennas and the antennas in the direction of +45 degrees among the third and fourth pairs of dual-polarized antennas of the 8 antennas are virtualized into the second port.

6. (canceled)

7. The method of claim 1, wherein the antennas in the direction of +45 degrees among the first and third pairs of dual-polarized antennas of the 8 antennas and the antennas in the direction of −45 degrees among the second and fourth pairs of dual-polarized antennas of the 8 antennas are virtualized into the first port and the antennas in the direction of −45 degrees among the first and third pairs of dual-polarized antennas of the 8 antennas and the antennas in the direction of +45 degrees among the second and fourth pairs of dual-polarized antennas of the 8 antennas are virtualized into the second port.

8. (canceled)

9. The method of claim 1, wherein
the antennas in the direction of +45 degrees among the first and fourth pairs of dual-polarized antennas of the 8 antennas and the antennas in the direction of −45 degrees among the second and third pairs of dual-polarized antennas of the 8 antennas are virtualized into the first port and the antennas in the direction of −45 degrees among the first and fourth pairs of dual-polarized antennas of the 8 antennas and the antennas in the direction of +45 degrees among the second and third pairs of dual-polarized antennas of the 8 antennas are virtualized into the second port.

10. (canceled)

11. The method of claim 1, wherein
the antennas in the direction of +45 degrees among the first, second, third and fourth pairs of dual-polarized antennas of the 8 antennas are virtualized into the first port and the antennas in the direction of −45 degrees among the first, second, third and fourth pairs of dual-polarized antennas of the 8 antennas are virtualized into the second port.

12. The method of claim 1, wherein the base station is a Long Term Evolution, LTE, Time Division Duplex, TDD, base station or an LTE-A TDD base station or an LTE Frequency Division Duplex, FDD, base station or an LTE-A FDD base station.

13. An apparatus for transmitting a downlink control channel on 8 antennas, comprising:
a port grouping module configured, for the 8 antennas used by a base station for downlink transmission, to virtualize 4 antennas among the 8 antennas into a first port and virtualize the other 4 antennas among the 8 antennas into a second port, wherein broadcast weights of the 4 antennas of the first port satisfy that the weight of one of the antennas is +1 and the weights of the remaining three antennas are −1, or the weight of one of the antennas is −1 and the weights of the remaining three antennas are +1; and broadcast weights of the 4 antennas of the second port satisfy that the weight of one of the antennas is +1 and the weights of the remaining three antennas are −1, or the weight of one of the antennas is −1 and the weights of the remaining three antennas are +1; and
a downlink control signal transmitting module configured to transmit a downlink control signal through the first port and the second port obtained by the port grouping module.

14. The apparatus of claim 13, wherein the port grouping module is configured to virtualize the first and third pairs of dual-polarized antennas among the 8 antennas into the first port and virtualize the second and fourth pairs of dual-polarized antennas among the 8 antennas into the second port.

15. The apparatus of claim 13, wherein the port grouping module is configured to virtualize
the first and fourth pairs of dual-polarized antennas among the 8 antennas into the first port and virtualize the second and third pairs of dual-polarized antennas among the 8 antennas into the second port.

16. (canceled)

17. The apparatus of claim 13, wherein the port grouping module is configured
to virtualize the antennas in the direction of +45 degrees among the first and second pairs of dual-polarized antennas of the 8 antennas and the antennas in the direction of −45 degrees among the third and fourth pairs of dual-polarized antennas of the 8 antennas into the first port and virtualize the antennas in the direction of −45 degrees among the first and second pairs of dual-polarized antennas of the 8 antennas and the antennas in the direction of +45 degrees among the third and fourth pairs of dual-polarized antennas of the 8 antennas into the second port.

18. (canceled)

19. The apparatus of claim 13, wherein the port grouping module is configured
to virtualize the antennas in the direction of +45 degrees among the first and third pairs of dual-polarized antennas of the 8 antennas and the antennas in the direction of −45 degrees among the second and fourth pairs of dual-polarized antennas of the 8 antennas into the first port and virtualize the antennas in the direction of −45 degrees among the first and third pairs of dual-polarized antennas of the 8 antennas and the antennas in the direction of +45 degrees among the second and fourth pairs of dual-polarized antennas of the 8 antennas into the second port.

20. (canceled)

21. The apparatus of claim 13, wherein the port grouping module is configured
to virtualize the antennas in the direction of +45 degrees among the first and fourth pairs of dual-polarized antennas of the 8 antennas and the antennas in the direction of −45 degrees among the second and third pairs of dual-polarized antennas of the 8 antennas into the first port and virtualize the antennas in the direction of −45 degrees among the first and fourth pairs of dual-polarized antennas of the 8 antennas and the antennas in the direction of +45 degrees among the second and third pairs of dual-polarized antennas of the 8 antennas into the second port.

22. (canceled)

23. The apparatus of claim 13, wherein the port grouping module is configured
to virtualize the antennas in the direction of +45 degrees among the first, second, third and fourth pairs of dual-polarized antennas of the 8 antennas into the first port and virtualize the antennas in the direction of −45 degrees among the first, second, third and fourth pairs of dual-polarized antennas of the 8 antennas into the second port.

24. The apparatus of claim 13, wherein the apparatus is located on a Long Term Evolution, LTE, Time Division Duplex, TDD, base station or on an LTE-A TDD base station or on an LTE Frequency Division Duplex, FDD, base station or on an LTE-A FDD base station.
